(19) United States
(12) Patent Application Publication
(10) Pub. No.: US 2025/0385613 A1
(43) Pub. Date: Dec. 18, 2025

(54) POWER CONVERSION CIRCUIT AND CONTROL METHOD THEREOF USING PULSE-WIDTH MODULATION

(71) Applicant: Richtek Technology Corporation, Zhubei City (TW)

(72) Inventors: Kuo-Chi LIU, Hsinchu City (TW); Ta-Yung YANG, Taoyuan City (TW); Yi-Min SHIU, Hsinchu City (TW); Tzu-Chen LIN, Zhubei City, Hsinchu County (TW)

(21) Appl. No.: 19/222,101

(22) Filed: May 29, 2025

Related U.S. Application Data
(60) Provisional application No. 63/660,600, filed on Jun. 17, 2024.

(30) Foreign Application Priority Data
Feb. 10, 2025 (TW) 114104849

(51) Int. Cl. H02M 3/335; H02M 1/00; H02M 1/38; H02M 3/00

(52) U.S. Cl. CPC H02M 3/33569; H02M 1/0009; H02M 1/0058; H02M 1/385; H02M 3/01

(57) ABSTRACT

A power conversion circuit converting an input voltage into an output voltage includes a transformer, a resonant capacitor, a high-side transistor, a low-side transistor, and a control circuit. The transformer includes a primary coil and a secondary coil. The resonant capacitor and the primary coil are coupled in series between a switch node and a ground, and a resonant current flows through the resonant capacitor. The high-side transistor is coupled between the input voltage and the switch node, and the low-side transistor is coupled between the switch node and the ground. The control circuit drives the high-side transistor and the low-side transistor based on the output voltage and the resonant current. When the resonant current reaches a first threshold, the control circuit turns off the low-side transistor so that the high-side transistor achieves zero-voltage switching.

### CROSS REFERENCE TO RELATED APPLICATIONS

This application claims the benefit of U.S. Provisional Application No. 63/660,600, filed on Jun. 17, 2025, the entirety of which is incorporated by reference herein.

This Application claims priority of Taiwan Patent Application No. 114104849, filed on Feb. 10, 2025, the entirety of which is incorporated by reference herein.

### BACKGROUND OF THE INVENTION

### Field of the Invention

The disclosure is generally related to a power conversion circuit and a control method thereof, and more particularly it is related to a power conversion circuit and a control method thereof using pulse-width modulation control.

### Description of the Related Art

With the continuous development of portable electronic devices, the developmental trend in the field of power conversion circuits is, like most power products, moving towards high efficiency, high power density, high reliability, and low cost. Since resonant power conversion circuits (including LLC resonant power conversion circuits, etc.) have the advantages of achieving zero-voltage switching (ZVS) on the primary side and zero-current switching (ZCS) of the rectification diode on the secondary side within the full load range. Further advantages include using frequency control to make sure that the duty cycles of the high-side transistor and the low-side transistor are both 50%; ensuring that no output inductor is required; and adapting lower voltage transistors on the secondary side to reduce costs and improve efficiency. As a result, they have increasingly been used in DC voltage converters in recent years.

However, due to the characteristics of the resonant power conversion circuit, a higher switching frequency must be used when the output voltage is low or the load is light, resulting in poor conversion efficiency of the resonant power conversion circuit. In order to meet the current market demand for a wide range of output voltages, high output power, and high conversion efficiency, it is necessary to further optimize the power conversion circuit to meet market demand.

### BRIEF SUMMARY OF THE INVENTION

The present invention proposes a resonant power conversion circuit and a control method thereof using pulse width modulation control, which meets the market demand for a wide range of output voltages, high output power, and high conversion efficiency. In addition, by turning on the high-side transistor and the low-side transistor under valley switching and zero-voltage switching, it helps to further improve the conversion efficiency of the resonant power conversion circuit.

In an embodiment, a power conversion circuit for converting an input voltage into an output voltage is provided, which comprises a transformer, a resonant capacitor, a high-side transistor, a low-side transistor, and a control circuit. The transformer comprises a primary coil and a secondary coil, where the primary coil is coupled between a switch node and a resonant node. The resonant capacitor is coupled between the resonant node and a ground, where a resonant current flows through the resonant capacitor. The high-side transistor is coupled between the input voltage and the switch node. The low-side transistor is coupled between the switch node and the ground. The control circuit drives the high-side transistor and the low-side transistor based on the output voltage and the resonant current. When the resonant current reaches a first threshold, the control circuit turns off the low-side transistor, so that the high-side transistor achieves zero-voltage switching. When the resonant current exceeds a second threshold, the control circuit turns off the high-side transistor. The second threshold is related to the input voltage.

According to an embodiment of the present invention, the power conversion circuit further comprises a rectification circuit, a feedback circuit, and a detection circuit. The rectification circuit is configured to convert energy of the secondary coil into the output voltage. The feedback circuit compares the output voltage with a reference voltage to generate a compensation signal. The detection circuit detects the resonant current to generate a current detection signal. When the current detection signal is lower than a zero-voltage current threshold, the control circuit turns off the low-side transistor, so that the high-side transistor achieves zero-voltage switching. When the current detection signal exceeds the compensation signal, the control circuit turns off the high-side transistor. The current detection signal corresponds to the resonant current, and the zero-voltage current threshold corresponds to the first threshold. The compensation signal corresponds to the second threshold.

According to an embodiment of the present invention, the zero-voltage current threshold is determined by parasitic capacitance of the high-side transistor, parasitic capacitance of the low-side transistor, the input voltage and a dead time. The dead time is the period between the low-side transistor being turned off to the high-side transistor being turned on.

According to an embodiment of the present invention, the detection circuit further detects a voltage across the resonant capacitor to generate a voltage detection signal. When the voltage detection signal is lower than a threshold voltage, the control circuit turns off the low-side transistor.

According to an embodiment of the present invention, the control circuit further comprises an error amplifier. The error amplifier compares the current detection signal and the zero-voltage current threshold to generate the threshold voltage.

According to an embodiment of the present invention, the control circuit further comprises a valley detection circuit. The valley detection circuit is configured to detect a voltage across the high-side transistor or the low-side transistor at a valley voltage to generate a valley detection signal. The control circuit turns on the corresponding high-side transistor or low-side transistor based on the valley detection signal to achieve valley switching.

According to an embodiment of the present invention, the control circuit further comprises a zero-current detection circuit. The zero-current detection circuit compares the current detection signal and a zero-current threshold to generate a zero-current detection signal. When the resonant current is zero, the zero-current detection circuit enables the zero-current detection signal. The control circuit turns on the high-side transistor or the low-side transistor based on the zero-current detection signal being enabled.

According to an embodiment of the present invention, the detection circuit comprises a detection capacitor and a detection resistor. The detection capacitor is coupled to the resonant node. The detection resistor is coupled between the detection capacitor and the ground. A voltage across the detection resistor is the current detection signal.

According to an embodiment of the present invention, the detection circuit comprises a detection resistor. The detection resistor is coupled between the resonant capacitor and the ground. A voltage across the detection resistor is the current detection signal.

According to an embodiment of the present invention, the detection circuit further comprises a capacitive voltage divider. The capacitive voltage divider is coupled to the resonant capacitor in parallel. The capacitive voltage divider is configured to generate the voltage detection signal using a voltage across the resonant capacitor.

In another embodiment, a power conversion circuit for converting an input voltage into an output voltage is provided, which comprises a transformer, a resonant capacitor, a resonant inductor, a high-side transistor, a low-side transistor, a rectification circuit, a feedback circuit, a detection circuit, and a control circuit. The transformer comprises a primary coil and a secondary coil. A resonant current flows through the resonant capacitor. The primary coil, the resonant capacitor, and the resonant inductor are connected in series between a switch node and a ground. The high-side transistor is coupled between the input voltage and the switch node. The low-side transistor is coupled between the switch node and the ground. The rectification circuit is configured to convert energy of the secondary coil into the output voltage. The feedback circuit compares the output voltage with a reference voltage to generate a compensation signal. The detection circuit detects the resonant current to generate a current detection signal. The control circuit drives the high-side transistor and the low-side transistor based on the current detection signal and the compensation signal. The control circuit controls a conduction time of the low-side transistor as a predetermined value. The predetermined value is less than half of a resonant period. The resonant period is determined by the resonant capacitor and the resonant inductor. When the current detection signal exceeds the compensation signal, the control circuit turns off the high-side transistor.

According to an embodiment of the present invention, the detection circuit comprises a zero-current detection circuit. The zero-current detection circuit compares the current detection signal with a zero-current threshold to generate a zero-current detection signal. When the resonant current is zero, the zero-current detection circuit enables the zero-current detection signal. The control circuit turns on the high-side transistor or the low-side transistor based on the zero-current detection signal being enabled.

In yet another embodiment, a control method for controlling a power conversion circuit is provided. The control method comprises a plurality of periods in a switching period. A first transistor in a primary side of the power conversion circuit is turned on and a second transistor in the primary side is turned off in a first driving period. After the first driving period, the first transistor and the second transistor are simultaneously turned off in a first reset period. After the first rest period, the first transistor is turned off and the second transistor is turned on in a second driving period. After the second driving period, the first transistor and the second transistor are simultaneously turned off in a second rest period. After the second rest period, the first transistor is turned on and the second transistor is turned off in a third driving period. After the third driving period, the first transistor and the second transistor are simultaneously turned off in a third rest period. After the third rest period, the first transistor is turned off and the second transistor is turned on in a fourth driving period. After the fourth driving period, the first transistor and the second transistor are simultaneously turned off in a fourth rest period.

According to an embodiment of the present invention, the control method further comprises the following steps. After the fourth rest period of a first switching period, the first driving period of a second switching period is begun. When the first transistor is turned on during the first driving period of the second switching period, the first transistor is turned on under valley switching.

According to an embodiment of the present invention, a length of the first driving period is related to an output voltage of the power conversion circuit.

According to an embodiment of the present invention, the control method further comprises the following steps. A length of the first rest period is adjusted to reduce a voltage across the second transistor when the second transistor is turned on during the second driving period.

According to an embodiment of the present invention, a length of the second driving period corresponds to whether the first transistor achieves zero-voltage switching during the third driving period.

According to an embodiment of the present invention, the control method further comprises the following steps. A length of the second driving period and a length of the second rest period are adjusted to reduce a voltage across the first transistor when the first transistor is turned on during the third driving period.

According to an embodiment of the present invention, a length of the third driving period corresponds to an output voltage of the power conversion circuit.

According to an embodiment of the present invention, the control method further comprises the following steps. A length of the third rest period is adjusted to reduce a voltage of the second transistor when the second transistor is turned on during the fourth driving period.

According to an embodiment of the present invention, the first transistor achieves zero-voltage switching when the first transistor is turned on during the third driving period. The first transistor achieves valley switching when the first transistor is turned on during the first driving period.

According to an embodiment of the present invention, the second transistor achieves zero-voltage switching when the second transistor is turned on during the second driving period. The second transistor achieves zero-voltage switching when the second transistor is turned on during the fourth driving period.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram of a power conversion circuit in accordance with an embodiment of the present invention;

FIG. 2 is a schematic diagram of a detection circuit in accordance with an embodiment of the present invention;

FIG. 3 is a schematic diagram of a control circuit in accordance with an embodiment of the present invention;

FIG. 4 is a schematic diagram of a control circuit in accordance with another embodiment of the present invention;

FIG. 5 is a waveform diagram of a power conversion circuit in accordance with an embodiment of the present invention;

FIG. 6 is a schematic diagram of a valley detection circuit in accordance with an embodiment of the present invention;

FIG. 7 is a schematic diagram of a control circuit in accordance with another embodiment of the present invention;

FIG. 8 is a waveform diagram of a power conversion circuit in accordance with another embodiment of the present invention;

FIG. 9 is a schematic diagram of a control circuit in accordance with another embodiment of the present invention;

FIG. 10 is a schematic diagram of a second zero-current detection circuit in accordance with an embodiment of the present invention;

FIG. 11 is a waveform diagram of a power conversion circuit in accordance with another embodiment of the present invention;

FIG. 12 is a waveform diagram of a power conversion circuit in accordance with another embodiment of the present invention;

FIG. 13 is a waveform diagram of a power conversion circuit in accordance with another embodiment of the present invention;

FIG. 14 is a simulation waveform diagram of a power conversion circuit in accordance with some embodiments of the present invention; and

FIG. 15 is a flow chart of a control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

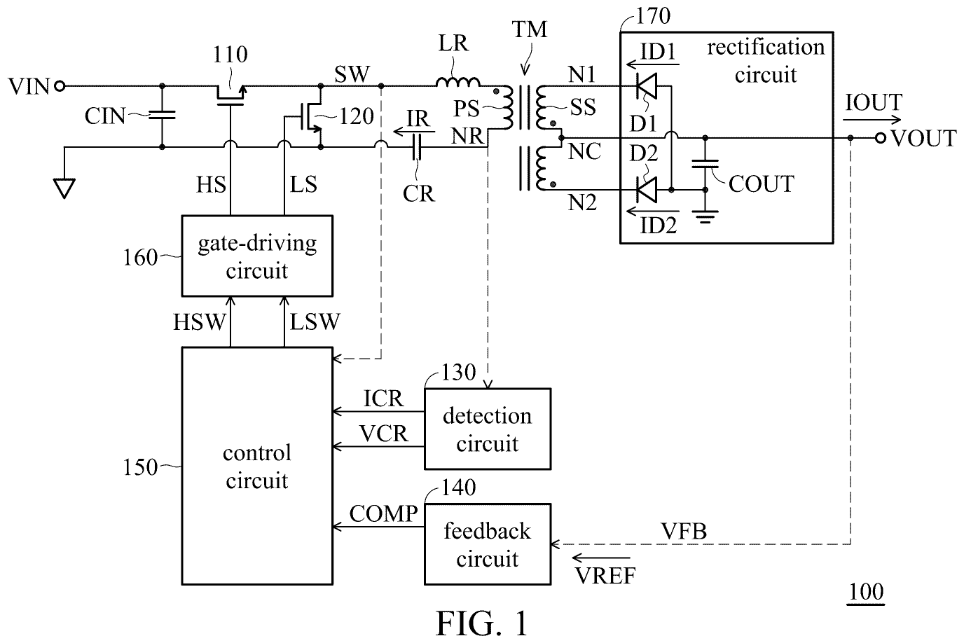

FIG. 1 is a schematic diagram of a power conversion circuit in accordance with an embodiment of the present invention. As shown in FIG. 1, the power conversion circuit 100 is configured to convert an input voltage VIN into an output voltage VOUT, and includes a transformer TM, a resonant inductor LR, a resonant capacitor CR, an input capacitor CIN, a high-side transistor 110, a low-side transistor 120, a detection circuit 130, a feedback circuit 140, a control circuit 150, and a gate-driving circuit 160.

The transformer TM includes a primary coil PS and a secondary coil SS, where the primary coil PS is coupled to a resonant node NR. The resonant inductor LR is coupled between a switch node SW and the primary coil PS, and the resonant capacitor CR is coupled between the resonant node NR and a ground. According to an embodiment of the present invention, the resonant inductor LR can be replaced by the leakage inductance of the primary coil PS of the transformer TM. In other words, the primary coil PS can be coupled between the switch node SW and the resonant node NR.

As shown in FIG. 1, the input capacitor CIN is coupled between the input voltage VIN and the ground. The high-side driving signal HS drives the high-side transistor 110 and provides the input voltage VIN to the switch node SW. The low-side driving signal LS drives the low-side transistor 120 and couples the switch node SW to the ground. According to some embodiments of the present invention, the high-side transistor 110 and the low-side transistor 120 form a half-bridge circuit to drive the primary coil PS and the resonant capacitor CR.

The detection circuit 130 is coupled to the resonant node NR to generate a current detection signal ICR and a voltage detection signal VCR. According to some embodiments of the present invention, the current detection signal ICR is configured to represent the resonant current IR flowing through the resonant capacitor CR, and the voltage detection signal VCR is configured to represent the voltage across the resonant capacitor CR. According to one embodiment of the present invention, the detection circuit 130 may include a detection resistor (not shown in FIG. 1) coupled between the resonant capacitor CR and the ground, where the voltage across the detection resistor is the current detection signal ICR. According to some embodiments of the present invention, the current detection signal ICR is a voltage signal.

The feedback circuit 140 is configured to compare the feedback voltage VFB with the reference voltage VREF to generate a compensation signal COMP. According to some embodiments of the present invention, the feedback voltage VFB is proportional to the output voltage VOUT. According to some embodiments of the present invention, the feedback circuit 140 may include an error amplifier, and the positive terminal of the error amplifier receives the reference voltage VREF, and the negative terminal receives the feedback voltage VFB. The feedback circuit 140 compares the output voltage VOUT with the reference voltage VREF to generate the compensation signal COMP. It is illustrated that the compensation signal COMP is generated by using the feedback voltage VFB herein, but not intended to be limited thereto. According to other embodiments of the present invention, the feedback circuit 140 may also compare the output voltage VOUT with the reference voltage VREF to generate the compensation signal COMP.

According to some embodiments of the present invention, the feedback circuit 140 generates the compensation signal COMP by using the difference between the feedback voltage VFB and the reference voltage VREF, causing that the output voltage VOUT reaches the target value and the feedback voltage VFB is equal to the reference voltage VREF. According to one embodiment of the present invention, when the feedback voltage VFB exceeds the reference voltage VREF, the feedback circuit 140 reduces the compensation signal COMP. According to another embodiment of the present invention, when the reference voltage VREF exceeds the feedback voltage VFB, the feedback circuit 140 increases the compensation signal COMP. According to an embodiment of the present invention, the feedback circuit 140 may include a voltage divider for dividing the output voltage VOUT to generate the feedback voltage VFB.

The control circuit 150 generates a high-side gate-driving signal HSW and a low-side gate-driving signal LSW based on the voltage of the current detection signal ICR, the voltage detection signal VCR, and the compensation signal COMP. The gate-driving circuit 160 generates a high-side driving signal HS based on the high-side gate-driving signal HSW, and generates a low-side driving signal LS based on the low-side gate-driving signal LSW.

According to other embodiments of the present invention, since the current detection signal ICR and the voltage detection signal VCR are both configured to detect the resonant current IR flowing through the resonant capacitor CR and the compensation signal COMP is configured to represent the state of the output voltage VOUT, it can be considered that the control circuit 150 drives the high-side transistor 110 and the low-side transistor 120 based on the output voltage VOUT and the resonant current IR.

As shown in FIG. 1, the power conversion circuit 100 further includes a rectification circuit 170. The rectification circuit 170 includes a first rectification unit D1, a second rectification unit D2, and an output capacitor COUT. The first rectification unit D1 is coupled between a first node N1 of the secondary coil SS and a ground. The second rectification unit D2 is coupled between a second node N2 of the secondary coil SS and a ground. The output capacitor COUT is coupled between an intermediate node NC of the secondary coil SS and the ground, and the output voltage VOUT is generated at the intermediate node NC.

According to some embodiments of the present invention, the first rectification unit D1 and the second rectification unit D2 rectify the energy of the secondary winding SS into the first current ID1 and the second current ID2 respectively, and the first current ID1 and the second current ID2 are provided to the output capacitor COUT, thereby generating an output voltage VOUT and an output current IOUT.

According to some embodiments of the present invention, the power conversion circuit 100 may be a resonant power conversion circuit. According to some embodiments of the present invention, the power conversion circuit 100 may be an LLC resonant power conversion circuit.

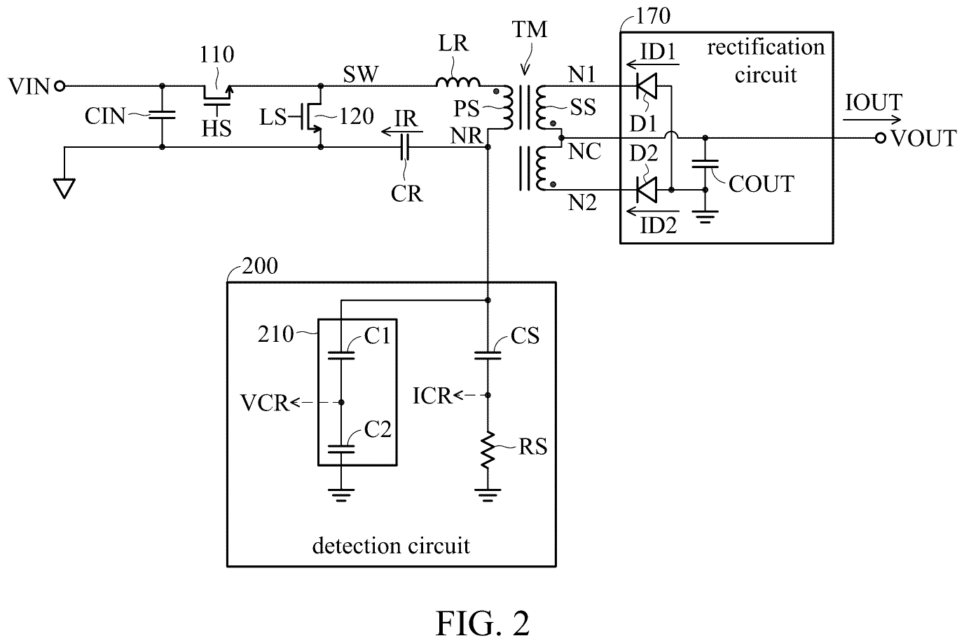

FIG. 2 is a schematic diagram of a detection circuit in accordance with an embodiment of the present invention. The detection circuit 200 includes a detection capacitor CS, a detection resistor RS, and a capacitive voltage divider 210. The detection capacitor CS is coupled to the resonant node NR, and the detection resistor RS is coupled between the detection capacitor CS and the ground. In other words, the detection capacitor CS and the detection resistor RS are connected in series across of the resonant capacitor CR. In addition, the voltage across the detection resistor RS generates a current detection signal ICR. According to some embodiments of the present invention, the current detection signal ICR is a voltage signal.

The capacitive voltage divider 210 is coupled across the resonant capacitor CR, and includes a first capacitor C1 and a second capacitor C2. The first capacitor C1 and the second capacitor C2 are configured to divide the voltage of the resonant node NR to generate a voltage detection signal VCR. According to other embodiments of the present invention, the detection resistor RS may also be connected between the resonant capacitor CR and the ground, and the detection capacitor CS is omitted (not shown in FIG. 2), where the voltage across the detection resistor RS is the current detection signal ICR.

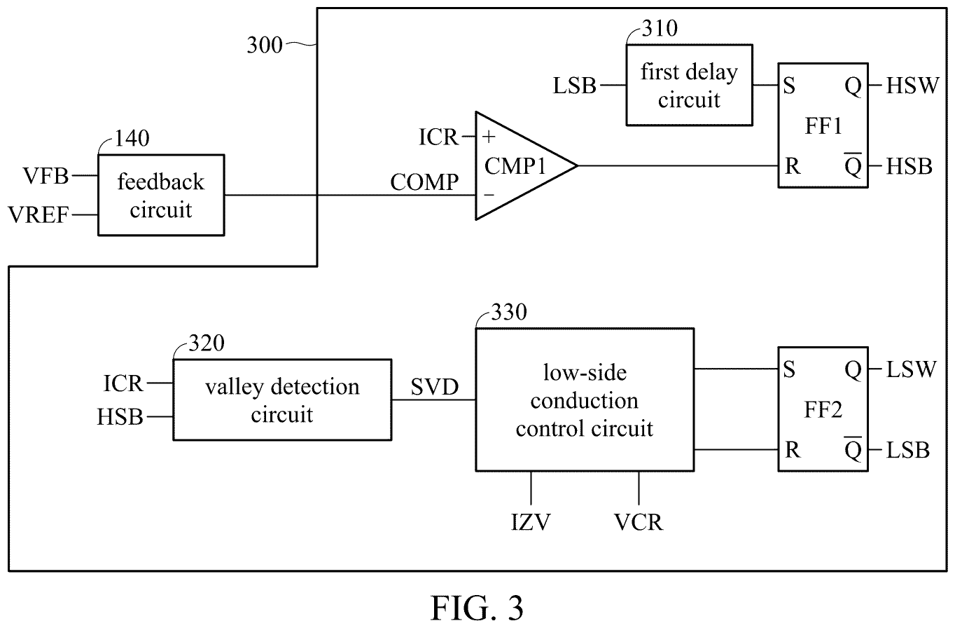

FIG. 3 is a schematic diagram of a control circuit in accordance with an embodiment of the present invention. As shown in FIG. 3, the control circuit 300 includes a first delay circuit 310, a first flip-flop FF1, a valley detection circuit 320, a low-side conduction control circuit 330, a second flip-flop FF2 and a first comparator CMP1.

The first flip-flop FF1 enables the high-side gate-driving signal HSW and simultaneously disables the inverted high-side gate-driving signal HSB based on the output signal generated by the first delay circuit 310 delaying the inverted low-side gate-driving signal LSB. According to some embodiments of the present invention, the delay time generated by the first delay circuit 310 is configured to determine the dead time from the turn-off of the low-side transistor 120 to the turn-on of the high-side transistor 110 in FIG. 1. The valley detection circuit 320 determines whether the voltage of the switch node SW is at the valley by detecting the state of the current detection signal ICR based on the inverted high-side gate-driving signal HSB being enabled, so as to generate a valley detection signal SVD.

The low-side conduction control circuit 330 sets or resets the second flip-flop FF2 based on the valley detection signal SVD, the zero-voltage current threshold IZV, and the voltage detection signal VCR, and thereby generates the low-side gate-driving signal LSW and the inverted low-side gate-driving signal LSB. According to some embodiments of the present invention, the low-side conduction control circuit 330 may control the conduction time of the low-side gate-driving signal LSW to be a predetermined value. According to one embodiment of the present invention, the predetermined value can be lower than the resonant period, where the resonant period is determined by the resonant capacitor CR and the resonant inductor LR in FIG. 1.

When the compensation signal COMP generated by the feedback circuit 140 of FIG. 1 does not exceed the current detection signal ICR, the first comparator CMP1 resets the first flip-flop FF1 to disable the high-side gate-driving signal HSW.

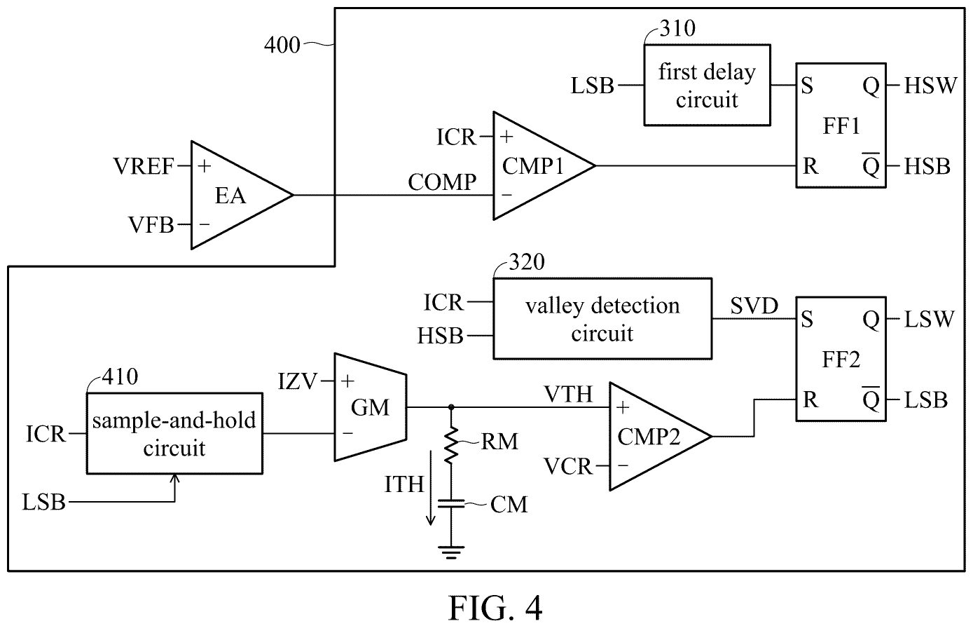

FIG. 4 is a schematic diagram of a control circuit in accordance with another embodiment of the present invention. Comparing the control circuit 400 of FIG. 4 with the control circuit 300 of FIG. 3, the low-side conduction control circuit 320 of FIG. 3 is replaced by a sample-and-hold circuit 410, a transconductance amplifier GM, a transconductance resistor RM, a transconductance capacitor CM, and a second comparator CMP2, and the feedback circuit 140 of FIG. 3 is replaced by an error amplifier EA. In other words, the feedback circuit 140 may include an error amplifier EA.

The valley detection circuit 320 detects the state of the current detection signal ICR based on the inverted high-side gate-driving signal HSB being enabled to generate a valley detection signal SVD. The second flip-flop FF2 enables the low-side gate-driving signal LSW and disables the inverted low-side gate-driving signal LSB based on the valley detection signal SVD being enabled. The sample-and-hold circuit 410 samples and holds the current detection signal ICR based on the inverted low-side gate-driving signal LSB being enabled.

The transconductance amplifier GM compares the current detection signal ICR held by the sample-and-hold circuit 410 with the zero-voltage current threshold value IZV to generate a threshold current ITH. The threshold current ITH flows through the transconductance resistor RM and the transconductance capacitor CM to generate a threshold voltage VTH. According to some embodiments of the present invention, the transconductance amplifier GM generates different threshold currents ITH based on different differences between the current detection signal ICR and the zero-voltage current threshold value IZV.

In other words, the transconductance amplifier GM, the transconductance resistor RM, and the transconductance capacitor CM generate different threshold voltages VTH based on different differences between the current detection signal ICR and the zero-voltage current threshold value IZV. According to some embodiments of the present invention, the transconductance amplifier GM, the transconductance resistor RM, and the transconductance capacitor CM form an error amplifier.

The second comparator CMP2 compares the voltage detection signal VCR and the threshold voltage VTH to reset the second flip-flop FF2, thereby disabling the low-side gate-driving signal LSW and enabling the inverted low-side gate-driving signal LSB.

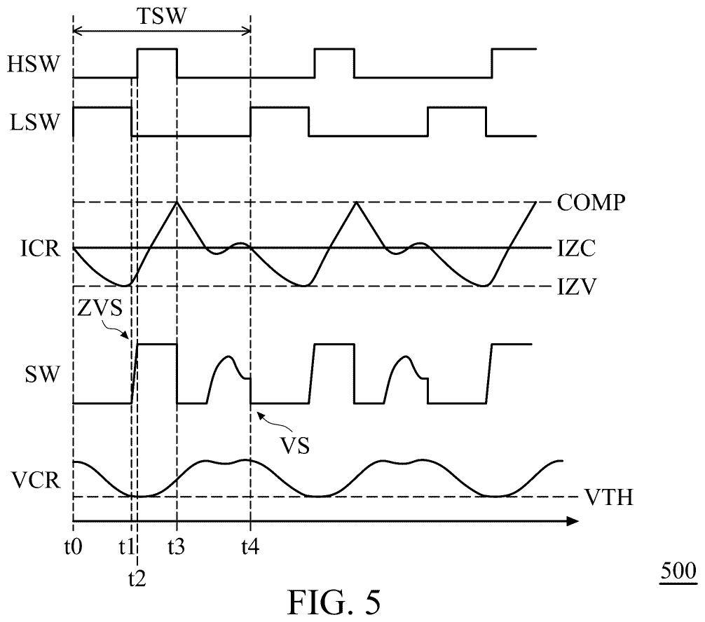

FIG. 5 is a waveform diagram of a power conversion circuit in accordance with an embodiment of the present invention. The power conversion circuit 100 of FIG. 1 and the control circuit 400 of FIG. 4 will be combined below for a detailed description. As shown in the waveform diagram 500 of FIG. 5, in a switching cycle TSW, the low-side gate-driving signal LSW is enabled at the initial time point t0. At the first time point t1, it is determined that the voltage detection signal VCR is lower than the threshold voltage VTH and the low-side gate-driving signal LSW is disabled.

According to some embodiments of the present invention, at the first time point t1, the current detection signal ICR reaches the zero-voltage current threshold IZV, and the voltage detection signal VCR is lower than the threshold voltage VTH generated by the transconductance amplifier GM, the transconductance resistor RM, and the transconductance capacitor CM, so that the high-side transistor 110 may be turned on under zero-voltage switching. The zero-voltage current threshold IZV is determined by the high-side parasitic capacitance COS1 of the high-side transistor 110, the low-side parasitic capacitance COS2 of the low-side transistor 120, the input voltage VIN, and the dead time TDT generated by the first delay circuit 310, as shown in Eq. 1.

$$I Z V = \frac{( COS 1 + COS 2 ) \times V I N}{T D T} \qquad ( Eq . 1 )$$

In other words, the resonant current IR flowing through the resonant capacitor CR must be sufficient to turn on the parasitic diode of the high-side transistor 110 so that the voltage of the switch node SW is equal to the input voltage VIN, thereby allowing the high-side transistor 110 that is subsequently turned on to achieve zero-voltage switching for reducing power loss.

After the dead time generated by the first delay circuit 310 in FIG. 4, the high-side gate-driving signal HSW is enabled at the second time point t2. According to an embodiment of the present invention, when the high-side transistor 110 is turned on at the second time point t2, zero-voltage switching (ZVS) can be achieved to reduce switching power loss. At the third time point t3, the current detection signal ICR exceeds the compensation signal COMP and the high-side gate-driving signal HSW is disabled.

After the third time point t3, the voltage of the switch node SW oscillates. The valley detection circuit 320 determines that the voltage of the switch node SW reaches the valley (i.e., the lowest point) at the fourth time point t4, and enables the low-side gate-driving signal LSW, so that the low-side transistor 120 achieves valley switching (VS).

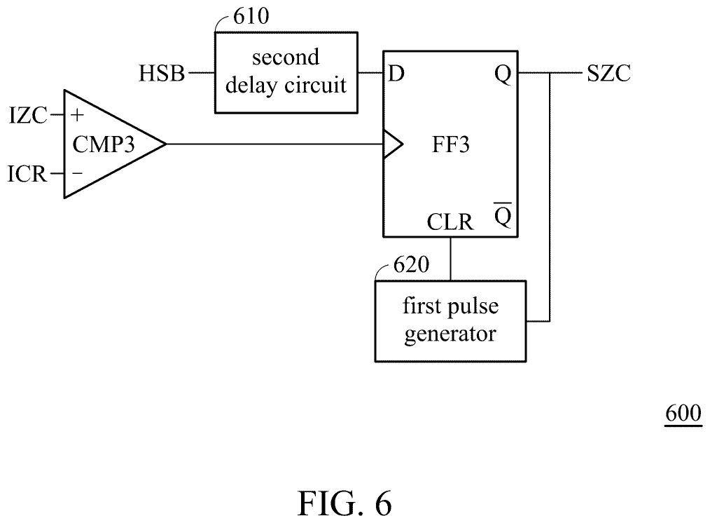

FIG. 6 is a schematic diagram of a valley detection circuit in accordance with an embodiment of the present invention. As shown in FIG. 6, the valley detection circuit 600 includes a second delay circuit 610, a third comparator CMP3, a third flip-flop FF3, and a first pulse generator 620. The second delay circuit 610 is configured to control the delay time of providing the inverted high-side gate-driving signal HSB to the third flip-flop FF3.

The third comparator CMP3 compares the current detection signal ICR with the zero-current threshold value IZC to generate a clock signal of the third flip-flop FF3. The third flip-flop FF3 outputs the inverted high-side gate-driving signal HSB provided by the second delay circuit 610 as a zero-current detection signal SZC based on the output signal of the third comparator CMP3.

According to some embodiments of the present invention, when the current detection signal ICR drops to the zero-current threshold value IZC, the third comparator CMP3 outputs a positive pulse, so that the third flip-flop FF3 outputs the inverted high-side gate-driving signal HSB as a zero-current detection signal SZC in response to the positive pulse output by the third comparator CMP3. According to some embodiments of the present invention, the zero-current threshold value IZC may be zero or slightly greater than zero. According to other embodiments of the present invention, the zero-current threshold value IZC may also be slightly less than zero. In other words, the zero-current threshold value IZC is a value close to zero.

When the inverted high-side gate-driving signal HSB is in the enabled state, the zero-current detection signal SZC output by the valley detection circuit 600 is also in the enabled state. The first pulse generator 620 resets the third flip-flop FF3 based on the enabled zero-current detection signal SZC. According to some embodiments of the present invention, the valley detection circuit 600 corresponds to the valley detection circuit 400 of FIG. 4, and is configured to detect that the current detection signal ICR drops to the zero-current threshold value IZC.

Since the zero-current threshold value IZC is a value close to zero, when the resonant current IR corresponding to the current detection signal ICR drops to zero, it indicates that the voltage of the switch node SW at this time is the minimum value. In other words, detecting that the current detection signal ICR drops to the zero-current threshold value IZC is equivalent to detecting that the voltage of the switch node SW reaches the valley. According to some embodiments of the present invention, the valley detection circuit 600 corresponds to the valley detection circuit 320 of FIG. 4, and the valley detection signal SVD of FIG. 4 corresponds to the zero-current detection signal SZC of FIG. 6.

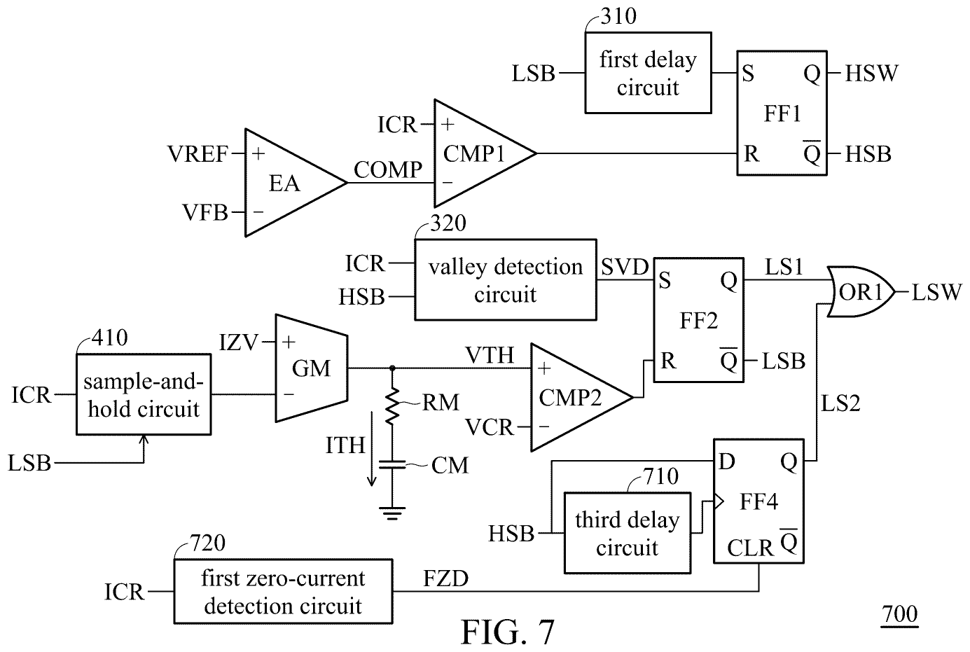

FIG. 7 is a schematic diagram of a control circuit in accordance with another embodiment of the present invention. Compared with the control circuit 400, the second flip-flop FF2 of the control circuit 700 outputs the first low-side gate-driving signal LS1, and the control circuit 700 further includes a third delay circuit 710, a fourth flip-flop FF4, a first zero-current detection circuit 720, and a first OR gate OR1.

As shown in FIG. 7, the third delay circuit 710 delays the inverted high-side gate-driving signal HSB by a delay time to be a clock signal of the fourth flip-flop FF4. The fourth flip-flop FF4 outputs the inverted high-side gate-driving signal HSB as the second low-side gate-driving signal LS2 based on the delayed inverted high-side gate-driving signal HSB.

The first zero-current detection circuit 720 is configured to detect that the current detection signal ICR drops to zero, so as to reset the fourth flip-flop FF4 and disable the second low-side gate-driving signal LS2. According to some embodiments of the present invention, the first zero-current detection circuit 720 may be implemented using the valley detection circuit 600. The first OR gate OR1 performs a logical OR operation on the first low-side gate-driving signal LS1 and the second low-side gate-driving signal LS2 to generate a low-side gate-driving signal LSW.

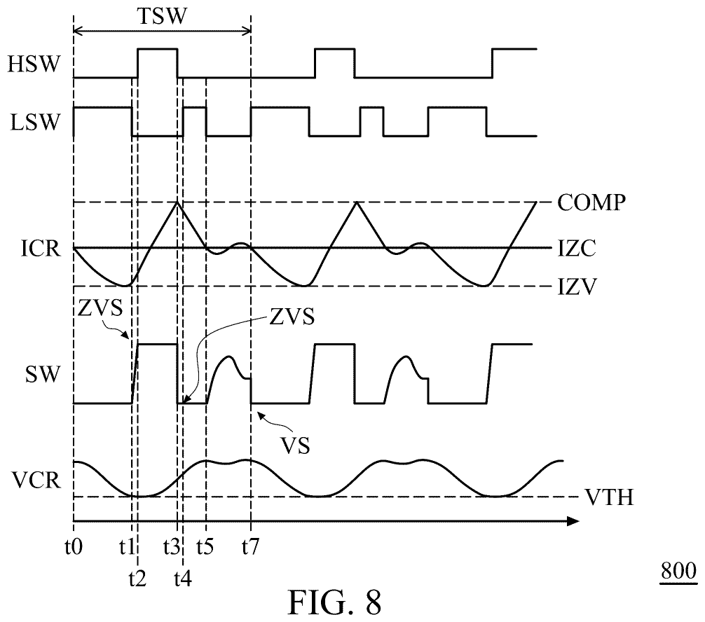

FIG. 8 is a waveform diagram of a power conversion circuit in accordance with another embodiment of the present invention. The power conversion circuit 100 of FIG. 1 and the control circuit 700 of FIG. 7 are combined below to facilitate detailed description. As shown in the waveform diagram 800 of FIG. 8, the initial time point t0 to the third time point t3 are the same as the waveform diagram 500 of FIG. 5, which will not be repeated herein.

After the high-side gate-driving signal HSW is turned off at the third time point t3, the third delay circuit 710 delays the inverted high-side gate-driving signal HSB to generate the output signal as the clock signal of the fourth flip-flop FF4, so that the low-side gate-driving signal LSW is enabled again at the fourth time point t4, thereby turning on the low-side transistor 120. According to some embodiments of the present invention, the dead time from the third time point t3 to the fourth time point t4 is determined by the delay time of the third delay circuit 710. According to some embodiments of the present invention, the dead time from the third time point t3 to the fourth time point t4 is sufficient to enable the low-side transistor 120 to achieve zero-voltage switching.

When the first zero-current detection circuit 720 determines that the current detection signal ICR drops to zero at the fifth time point t5, the first zero-current detection circuit 720 generates a falling zero-current signal FZD to reset the fourth flip-flop FF4, thereby disabling the low-side gate-driving signal LSW. At the seventh time point t7, the valley detection circuit 320 determines that the voltage of the switch node SW reaches the valley (i.e., the lowest point), and enables the low-side gate-driving signal LSW, so that the low-side transistor 120 achieves valley switching.

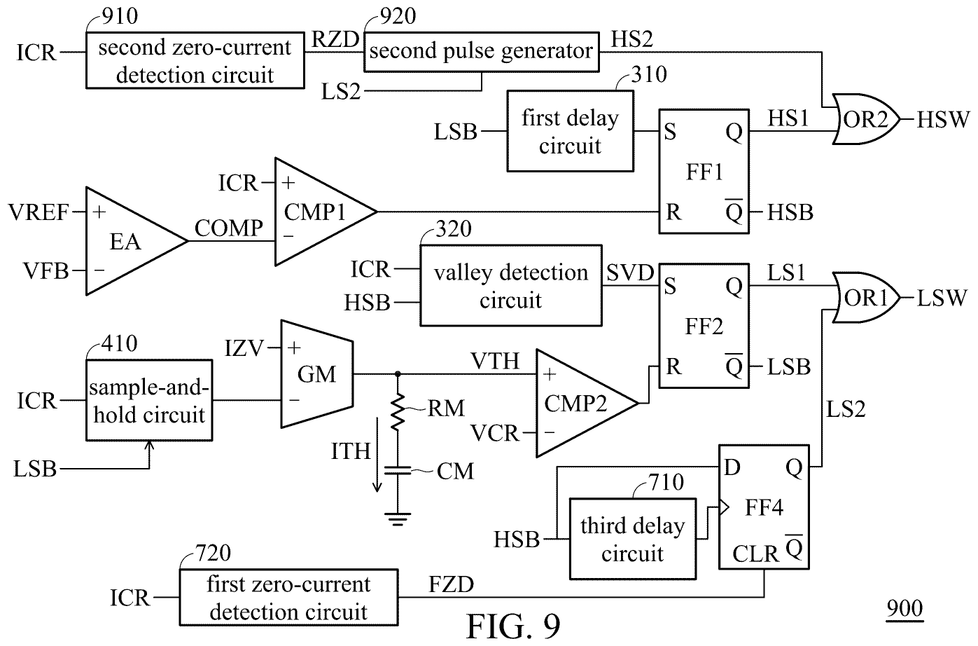

FIG. 9 is a schematic diagram of a control circuit in accordance with another embodiment of the present invention. Compared with the control circuit 700, the first flip-flop FF1 of the control circuit 900 outputs the first high-side gate-driving signal HS1, and the control circuit 900 further includes a second zero-current detection circuit 910, a second pulse generator 920, and a second OR gate OR2.

The second zero-current detection circuit 910 is configured to detect that the current detection signal ICR rises to zero to generate a rising zero-current signal RZD. The second pulse generator 920 is enabled by the second low-side gate-driving signal LS2, and generates a second high-side gate-driving signal HS2 based on the rising zero-current signal RZD. According to some embodiments of the present invention, the enabling time of the second high-side gate-driving signal HS2 is determined by the pulse width generated by the second pulse generator 920. The second OR gate OR2 performs a logical OR operation on the first high-side gate-driving signal HS1 and the second high-side gate-driving signal HS2 to generate the high-side gate-driving signal HSW.

In addition, compared with the control circuit 700, the valley detection circuit 320 of the control circuit 900 generates the valley detection signal SVD based on the second high-side gate-driving signal HS2 and the current detection signal ICR. As shown in FIG. 6, the inverted high-side gate-driving signal HSB received by the valley detection circuit 600 is replaced with the second high-side gate-driving signal HS2, so that the valley detection circuit 320 of the control circuit 900 can be realized.

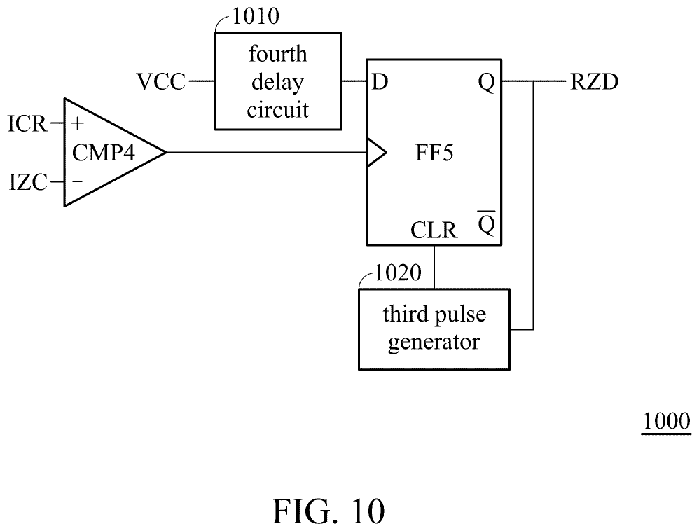

FIG. 10 is a schematic diagram of a second zero-current detection circuit in accordance with an embodiment of the present invention. As shown in FIG. 10, the second zero-current detection circuit 1000 includes a fourth delay circuit 1010, a fourth comparator CMP4, a fifth flip-flop FF5, and a third pulse generator 1020. The fourth delay circuit 1010 is configured to control the delay time of providing the supply voltage VCC to the fifth flip-flop FF5. When the current detection signal ICR increases to the zero-current threshold value IZC, the fourth comparator CMP4 outputs a positive pulse.

The fifth flip-flop FF5 outputs the supply voltage VCC as a rising zero-current signal RZD based on the rising edge generated by the fourth comparator CMP4. The third pulse generator 1020 resets the fifth flip-flop FF5 based on the rising zero-current signal RZD. In other words, when the current detection signal ICR increases to the zero-current threshold value IZC, the second zero-current detection circuit 1000 generates a positive pulse in the rising zero-current signal RZD.

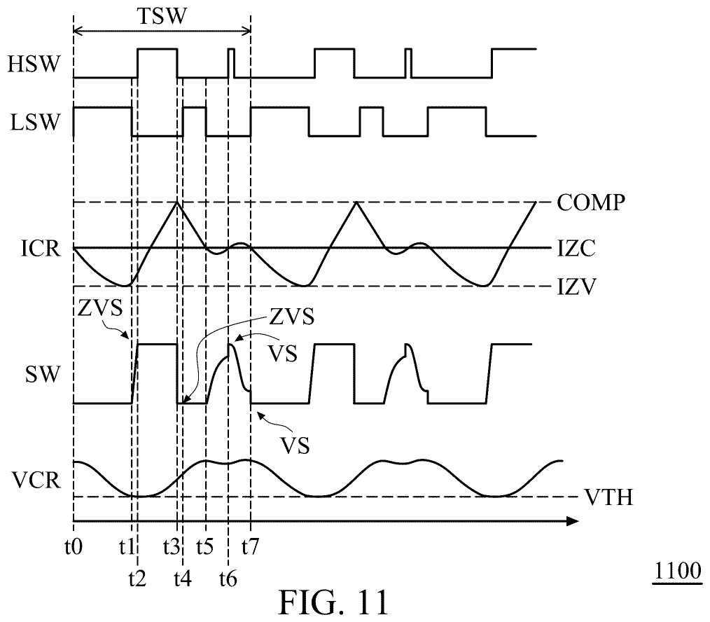

FIG. 11 is a waveform diagram of a power conversion circuit in accordance with another embodiment of the present invention. The power conversion circuit 100 of FIG. 1 and the control circuit 900 of FIG. 9 are combined for detailed description. As shown in the waveform diagram 1100 of FIG. 11, the initial time point t0 to the fifth time point t5 are the same as those of FIG. 8, which will not be repeated herein.

At the sixth time point t6, the second zero-current detection circuit 910 detects that the current detection signal ICR increases to the zero-current threshold value IZC to enable the high-side gate-driving signal HSW, so that the voltage of the switch node SW rises to the input voltage VIN. According to some embodiments of the present invention, the second zero-current detection circuit 910 is a valley detection circuit for detecting that the voltage across the high-side transistor 110 is at a valley voltage, and the valley detection circuit 320 is configured to detect that the voltage across the low-side transistor 120 is at a valley voltage to generate a valley detection signal SVD.

In addition, a higher voltage of the switch node SW helps to generate a lower valley voltage of the switch node SW. Therefore, when the low-side transistor 120 is turned on at the seventh time point t7, the valley voltage of the switch node SW is lower than the valley voltage of the switch node SW at the seventh time point t7 in FIG. 8. In other words, turning on the high-side transistor 110 again at the sixth time point t6 helps to increase the conversion efficiency of the power conversion circuit 100. According to some embodiments of the present invention, when the voltage across the high-side transistor 110 or the low-side transistor 120 is not equal to zero, it means that the parasitic capacitance of the high-side transistor 110 or the low-side transistor 120 still has charge. At this time, turning on the high-side transistor 110 or the low-side transistor 120 requires discharging the charge stored in the parasitic capacitance and converting it into heat. Therefore, zero-voltage switching can improve conversion efficiency more than valley switching.

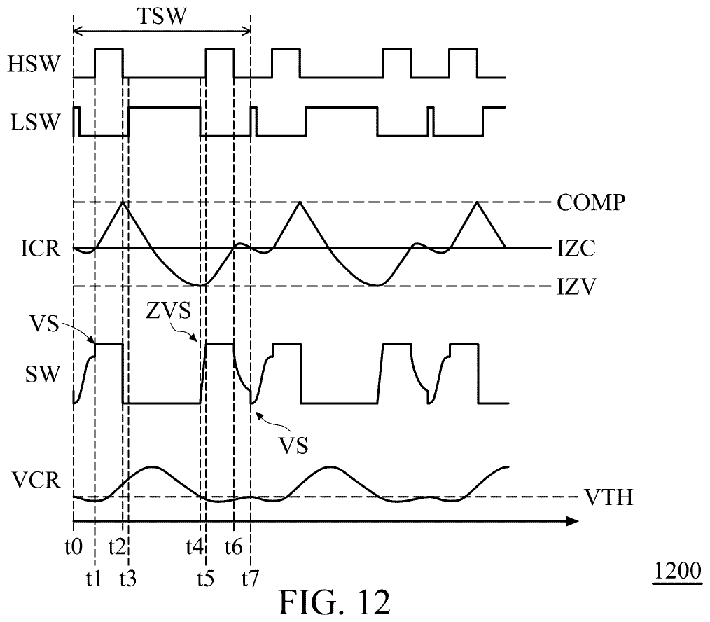

FIG. 12 is a waveform diagram of a power conversion circuit in accordance with another embodiment of the present invention. The following will combine the power conversion circuit 100 of FIG. 1 and the control circuit 900 of FIG. 9 for detailed description.

As shown in the waveform diagram 1200 of FIG. 12, the low-side transistor 120 is turned on under valley switching at the initial time point t0. From the initial time point t0 to the first time point t1, the voltage of the switch node SW rises, and the high-side transistor 110 is turned on under valley switching at the first time point t1. At the second time point t2, the current detection signal ICR exceeds the compensation signal COMP, and the high-side transistor 110 is turned off. Then, the low-side transistor 120 is turned on at the third time point t3, where the second time point t2 to the third time point t3 is a dead time and is determined by the second delay circuit 610 of FIG. 6.

When the current detection signal ICR reaches the zero-voltage current threshold value IZV, the low-side transistor 120 is turned off, so that the high-side transistor 110 can be turned on under zero-voltage switching at the fifth time point t5. In other words, when the resonant current IR is sufficient (i.e., the resonant current IR flowing from the resonant node NR to the switch node SW is sufficient to turn on the parasitic diode of the high-side transistor 110 to rise the voltage of the switch node SW to the input voltage VIN), the low-side transistor 120 may be turned off.

When the current detection signal ICR increases to the zero-current threshold value IZC at the sixth time point t6, the high-side transistor 110 is turned off. Then, the low-side transistor is turned on again at the seventh time point t7. According to some embodiments of the present invention, since both the high-side transistor 110 and the low-side transistor 120 are turned on under valley switching or zero-voltage switching, the conversion efficiency of the power conversion circuit 100 is improved.

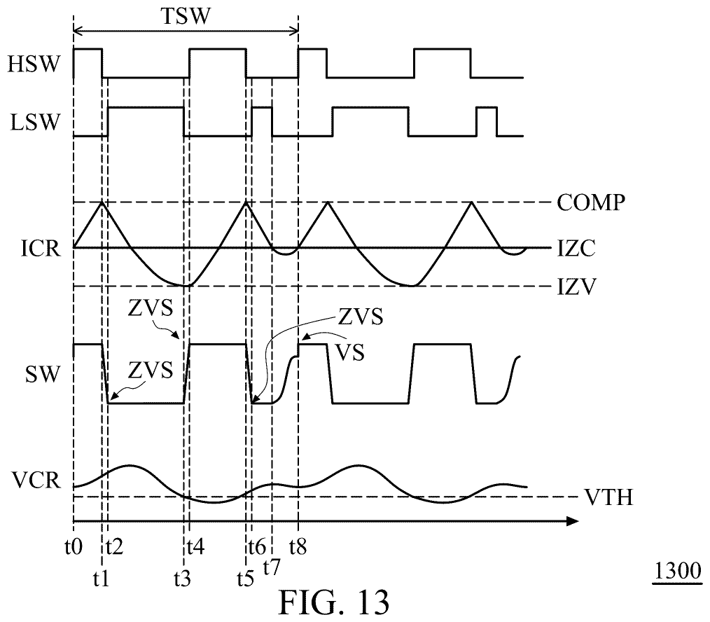

FIG. 13 is a waveform diagram of a power conversion circuit in accordance with another embodiment of the present invention. The power conversion circuit 100 of FIG. 1 and the control circuit 900 of FIG. 9 are combined to facilitate detailed description.

As shown in the waveform diagram 1300 of FIG. 13, the high-side transistor 110 is turned on at the initial time point t0 for valley switching, and the current detection signal ICR continues to increase between the initial time point t0 and the first time point t1. When the current detection signal ICR exceeds the compensation signal COMP at the first time point t1, the high-side transistor 110 is turned off. After the dead time, the low-side transistor 120 is turned on at the second time point t2. When the current detection signal ICR reaches the zero-voltage current threshold value IZV at the third time point t3, the low-side transistor 120 is turned off, so that the high-side transistor 110 is turned on at the fourth time point t4 under zero-voltage switching.

Next, when the current detection signal ICR exceeds the compensation signal COMP at the fifth time point t5, the high-side transistor 110 is turned off. After the dead time, the low-side transistor 120 is turned on at the sixth time point t6. When the current detection signal ICR drops to the zero-current threshold value IZC, the low-side transistor 120 is turned off at the seventh time point t7. From the seventh time point t7 to the eighth time point t8, the high-side transistor 110 and the low-side transistor 120 are both turned off, and the voltage of the switch node SW rises. Finally, the high-side transistor 110 is turned on again at the eighth time point t8.

Compared with the waveform 1100 of FIG. 11 having two times of valley switching in four times of transistor conduction, the waveform 1300 reduces the number of valley switching to one, which helps to ensure that the power loss is kept at a low level. Since both the high-side transistor 110 and the low-side transistor 120 are turned on under the conditions of zero-voltage switching or valley switching, and the resonant current IR flowing through the resonant capacitor CR is zero during valley switching, the conversion efficiency of the power conversion circuit 100 is improved.

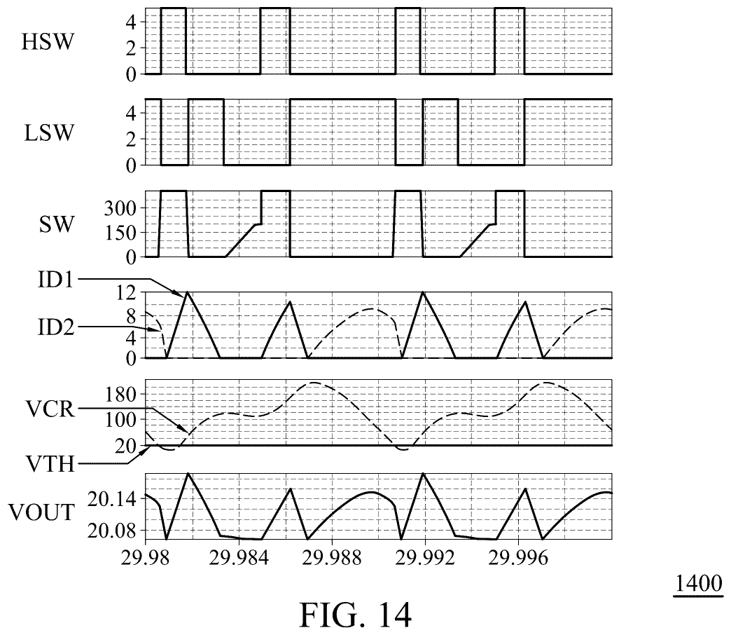

FIG. 14 is a simulation waveform diagram of a power conversion circuit in accordance with some embodiments of the present invention. According to an embodiment of the present invention, the simulation conditions of the simulation waveform diagram 1400 are: the input voltage VIN is 400V, the output voltage VOUT is 20V, and the output current IOUT is 5 A.

The high-side transistor 110 is turned on under valley switching or zero-voltage switching based on the high-side gate-driving signal HSW. The low-side transistor 120 is turned on under zero-voltage switching based on the low-side gate-driving signal LSW. In addition, when the current detection signal ICR rises to zero, the high-side transistor 110 is turned on under valley switching.

Since valley switching is to turn on the switch when the current flowing through the switch is zero, and zero-voltage switching is to turn on the switch when the voltage across the switch is zero, both valley switching and zero-voltage switching help to improve the conversion efficiency of the power conversion circuit. In addition, since the conduction periods of the high-side transistor 110 and the low-side transistor 120 of the power conversion circuit 100 do not need to be maintained equal, a wide range of output voltage VOUT can be achieved by adjusting the conduction period.

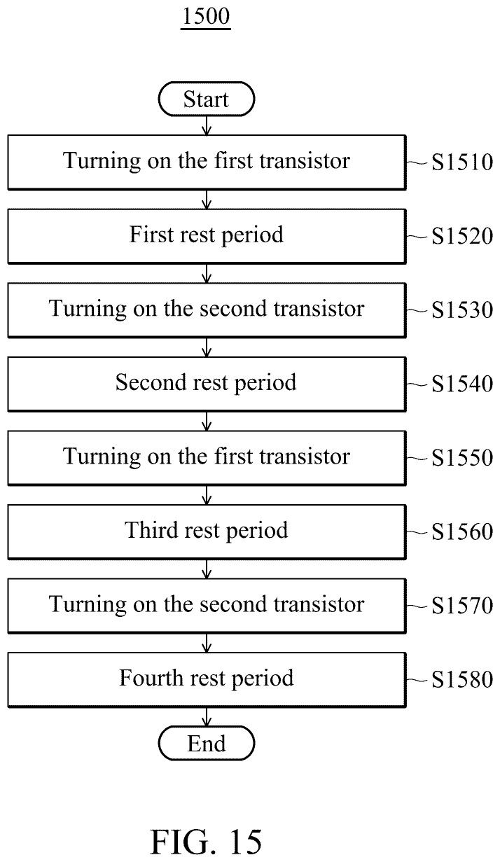

FIG. 15 is a flow chart of a control method in accordance with an embodiment of the present invention. The following description of the control method 1500 will be combined with FIGS. 1, 9, and 13 for detailed description. According to other embodiments of the present invention, the control method 1500 can also be applied to the waveform diagram 1100 of FIG. 11 and the waveform diagram 1200 of FIG. 12. In order to simplify the description, the waveform diagram 1300 of FIG. 13 is illustrated herein, but not intended to be limited thereto.

First, at the initial time point t0 of FIG. 13, the first transistor (i.e., the high-side transistor 110 in the embodiment of FIG. 13) is turned on (Step S1510), and the first transistor is continuously turned on between the initial time point t0 and the first time point t1 (i.e., the first driving period). At the first time point t1, the first transistor (i.e., the high-side transistor 110 in the embodiment of FIG. 13) and the second transistor (i.e., the low-side transistor 120 in the embodiment of FIG. 13) are turned off at the same time (Step S1520).

According to one embodiment of the present invention, the first time point t1 to the second time point t2 is the first rest period, also known as the dead time. According to some embodiments of the present invention, the control circuit 150 of FIG. 1 adjusts the length of the first rest period so that the second transistor (i.e., the low-side transistor 120 in the embodiment of FIG. 13) achieves zero-voltage switching when it is turned on at the second time point t2. According to some embodiments of the present invention, the length of the first rest period is determined by the valley detection circuit 320 of FIG. 9. As shown in FIG. 6, the first rest period is determined by the second delay circuit 610.

At the second time point t2, the second transistor is turned on (Step S1530) and still turned on for the second conduction time. According to some embodiments of the present invention, the second time point t2 to the third time point t3 is the second driving period. According to some embodiments of the present invention, the length of the second driving period is related to whether the first transistor can achieve zero-voltage switching at the fourth time point t4 in the third driving period.

As shown in FIGS. 9 and 13, when the second comparator CMP2 determines that the voltage detection signal VCR is not lower than the threshold voltage VTH, the second comparator CMP2 resets the second flip-flop FF2 and disables the low-side gate-driving signal LSW, thereby turning off the second transistor (i.e., the low-side transistor 120 in the embodiment of FIG. 13). According to some embodiments of the present invention, the length of the second driving period from the second time point t2 to the third time point t3 is configured to determine the size of the resonant current IR flowing from the resonant node NR to the switch node SW.

At the third time point t3, the first transistor and the second transistor are turned off at the same time (Step S1540) for the second rest period. According to some embodiments of the present invention, the third time point t3 to the fourth time point t4 is the second rest period. According to some embodiments of the present invention, the second rest period is determined by the first delay time 310 of FIG. 9. According to some embodiments of the present invention, the length of the second driving period and the second rest period can be adjusted to ensure that the first transistor (i.e., the high-side transistor 110 in the embodiment of FIG. 13) can be turned on under zero-voltage switching at the fourth time point t4.

At the fourth time point t4, the first transistor is turned on (Step S1550) for the third driving period. According to some embodiments of the present invention, the fourth time point t4 to the fifth time point t5 is the third driving period. According to some embodiments of the present invention, the length of the third driving period is related to the output voltage VOUT. As shown in FIG. 13, when the current detection signal ICR exceeds the compensation signal COMP related to the output voltage VOUT, the first transistor (i.e., the high-side transistor 110 in the embodiment of FIG. 13) is turned off.

At the fifth time point t5, the first transistor and the second transistor are turned off at the same time (Step S1560) for the third rest period. According to some embodiments of the present invention, the fifth time point t5 to the sixth time point t6 is the third rest period. According to some embodiments of the present invention, the third rest period is determined by the third delay circuit 710.

At the sixth time point t6, the second transistor is turned on (Step S1570) and the fourth driving period is continued. According to some embodiments of the present invention, the sixth time point t6 to the seventh time point t7 is the fourth driving period. At the seventh time point t7, the first transistor and the second transistor are turned off at the same time (Step S1580) for the fourth rest period. According to some embodiments of the present invention, the seventh time point t7 to the eighth time point t8 is the fourth rest period.

According to one embodiment of the present invention, when the first zero-current detection circuit 720 determines that the current detection signal ICR drops to the zero-current threshold value IZC, the first zero-current detection circuit 720 generates a falling zero-current signal FZD to turn off the second transistor (i.e., the low-side transistor 120 in the embodiment of FIG. 13) at the seventh time point t7. In other words, when the resonant current IR flowing through the resonant capacitor CR is zero, the second transistor (i.e., the low-side transistor 120 in the embodiment of FIG. 13) is turned off.

At the eighth time point t8, i.e., the initial time point t0 of the next switching cycle TSW, the first transistor (i.e., the high-side transistor 110 in the embodiment of FIG. 13) is turned on. According to some embodiments of the present invention, when the current detection signal ICR increases to the zero-current threshold value IZC, the first transistor (i.e., the high-side transistor 110 in the embodiment of FIG. 13) is turned on. In other words, when the resonant current IR increases to zero, the first transistor (i.e., the high-side transistor 110 in the embodiment of FIG. 13) is turned on.

The present invention proposes a resonant power conversion circuit and a control method thereof using pulse width modulation control, which meets the market demand for a wide range of output voltages, high output power, and high conversion efficiency. In addition, by turning on the high-side transistor and the low-side transistor under valley switching and zero-voltage switching, it helps to further improve the conversion efficiency of the resonant power conversion circuit.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit for converting an input voltage into an output voltage, comprising:
a transformer, comprising a primary coil and a secondary coil, wherein the primary coil is coupled between a switch node and a resonant node;
a resonant capacitor, coupled between the resonant node and a ground, wherein a resonant current flows through the resonant capacitor;
a high-side transistor, coupled between the input voltage and the switch node;
a low-side transistor, coupled between the switch node and the ground; and
a control circuit, driving the high-side transistor and the low-side transistor based on the output voltage and the resonant current;
wherein when the resonant current reaches a first threshold, the control circuit turns off the low-side transistor, so that the high-side transistor achieves zero-voltage switching;
wherein when the resonant current exceeds a second threshold, the control circuit turns off the high-side transistor;
wherein the second threshold is related to the input voltage.

2. The power conversion circuit as claimed in claim 1, further comprising:
a rectification circuit, configured to convert energy of the secondary coil into the output voltage;
a feedback circuit, comparing the output voltage with a reference voltage to generate a compensation signal; and
a detection circuit, detecting the resonant current to generate a current detection signal;
wherein when the current detection signal is lower than a zero-voltage current threshold, the control circuit turns off the low-side transistor, so that the high-side transistor achieves zero-voltage switching;
wherein when the current detection signal exceeds the compensation signal, the control circuit turns off the high-side transistor;
wherein the current detection signal corresponds to the resonant current, and the zero-voltage current threshold corresponds to the first threshold;
wherein the compensation signal corresponds to the second threshold.

3. The power conversion circuit as claimed in claim 2, wherein the zero-voltage current threshold is determined by parasitic capacitance of the high-side transistor, parasitic capacitance of the low-side transistor, the input voltage and a dead time;
wherein the dead time is a period between the low-side transistor being turned off to the high-side transistor being turned on.

4. The power conversion circuit as claimed in claim 2, wherein the detection circuit further detects a voltage across the resonant capacitor to generate a voltage detection signal;
wherein when the voltage detection signal is lower than a threshold voltage, the control circuit turns off the low-side transistor.

5. The power conversion circuit as claimed in claim 4, wherein the control circuit further comprises:
an error amplifier, comparing the current detection signal and the zero-voltage current threshold to generate the threshold voltage.

6. The power conversion circuit as claimed in claim 2, wherein the control circuit further comprises:
a valley detection circuit, configured to detect a voltage across the high-side transistor or the low-side transistor at a valley voltage to generate a valley detection signal;
wherein the control circuit turns on the corresponding high-side transistor or low-side transistor based on the valley detection signal to achieve valley switching.

7. The power conversion circuit as claimed in claim 2, wherein the control circuit further comprises:
a zero-current detection circuit, comparing the current detection signal and a zero-current threshold to generate a zero-current detection signal;
wherein when the resonant current is zero, the zero-current detection circuit enables the zero-current detection signal;
wherein the control circuit turns on the high-side transistor or the low-side transistor based on the zero-current detection signal being enabled.

8. The power conversion circuit as claimed in claim 2, wherein the detection circuit comprises:
a detection capacitor, coupled to the resonant node; and
a detection resistor, coupled between the detection capacitor and the ground;
wherein a voltage across the detection resistor is the current detection signal.

9. The power conversion circuit as claimed in claim 2, wherein the detection circuit comprises:
a detection resistor, coupled between the resonant capacitor and the ground;
wherein a voltage across the detection resistor is the current detection signal.

10. The power conversion circuit as claimed in claim 2, wherein the detection circuit further comprises:
a capacitive voltage divider, coupled to the resonant capacitor in parallel;
wherein the capacitive voltage divider is configured to generate the voltage detection signal using a voltage across the resonant capacitor.

11. A power conversion circuit for converting an input voltage into an output voltage, comprising:
a transformer, comprising a primary coil and a secondary coil;
a resonant capacitor, wherein a resonant current flows through the resonant capacitor;
a resonant inductor, wherein the primary coil, the resonant capacitor, and the resonant inductor are connected in series between a switch node and a ground;
a high-side transistor, coupled between the input voltage and the switch node;
a low-side transistor, coupled between the switch node and the ground;
a rectification circuit, configured to convert energy of the secondary coil into the output voltage;
a feedback circuit, comparing the output voltage with a reference voltage to generate a compensation signal;
a detection circuit, detecting the resonant current to generate a current detection signal; and
a control circuit, driving the high-side transistor and the low-side transistor based on the current detection signal and the compensation signal;
wherein the control circuit controls a conduction time of the low-side transistor as a predetermined value;
wherein the predetermined value is less than half of a resonant period;
wherein the resonant period is determined by the resonant capacitor and the resonant inductor;
wherein when the current detection signal exceeds the compensation signal, the control circuit turns off the high-side transistor.

12. The power conversion circuit as claimed in claim 11, wherein the detection circuit comprises:
a zero-current detection circuit, comparing the current detection signal with a zero-current threshold to generate a zero-current detection signal;
wherein when the resonant current is zero, the zero-current detection circuit enables the zero-current detection signal;
wherein the control circuit turns on the high-side transistor or the low-side transistor based on the zero-current detection signal being enabled.

13. A control method for controlling a power conversion circuit, wherein the control method comprises:
a plurality of periods in a switching period:
turning on a first transistor in a primary side in the power conversion circuit and turning off a second transistor in the primary side in a first driving period;
after the first driving period, simultaneously turning off the first transistor and the second transistor in a first reset period;
after the first rest period, turning off the first transistor and turning on the second transistor in a second driving period;
after the second driving period, simultaneously turning off the first transistor and the second transistor in a second rest period;
after the second rest period, turning on the first transistor and turning off the second transistor in a third driving period;
after the third driving period, simultaneously turning off the first transistor and the second transistor in a third rest period;
after the third rest period, turning off the first transistor and turning on the second transistor in a fourth driving period; and
after the fourth driving period, simultaneously turning off the first transistor and the second transistor in a fourth rest period.

14. The control method as claimed in claim 13, further comprising:
after the fourth rest period of a first switching period, beginning the first driving period of a second switching period;
wherein when the first transistor is turned on during the first driving period of the second switching period, the first transistor is turned on under valley switching.

15. The control method as claimed in claim 13, wherein a length of the first driving period is related to an output voltage of the power conversion circuit.

16. The control method as claimed in claim 13, further comprising:
adjusting a length of the first rest period to reduce a voltage across the second transistor when the second transistor is turned on during the second driving period.

17. The control method as claimed in claim 13, wherein a length of the second driving period corresponds to whether the first transistor achieves zero-voltage switching during the third driving period.

18. The control method as claimed in claim 17, further comprising:
Adjusting a length of the second driving period and a length of the second rest period to reduce a voltage across the first transistor when the first transistor is turned on during the third driving period.

19. The control method as claimed in claim 13, wherein a length of the third driving period corresponds to an output voltage of the power conversion circuit.

20. The control method as claimed in claim 17, further comprising:
adjusting a length of the third rest period to reduce a voltage of the second transistor when the second transistor is turned on during the fourth driving period.

21. The control method as claimed in claim 13, wherein the first transistor achieves zero-voltage switching when the first transistor is turned on during the third driving period;
wherein the first transistor achieves valley switching when the first transistor is turned on during the first driving period.

22. The control method as claimed in claim 13, wherein the second transistor achieves zero-voltage switching when the second transistor is turned on during the second driving period;
wherein the second transistor achieves zero-voltage switching when the second transistor is turned on during the fourth driving period.
